(19) United States
(12) Patent Application Publication
(10) Pub. No.: US 2025/0373097 A1
(43) Pub. Date: Dec. 4, 2025

(54) ROTARY ELECTRIC MACHINE

(71) Applicant: DENSO CORPORATION, Kariya-city (JP)

(72) Inventors: TAKASHI MAKINO, Kariya-city (JP); NAOKI TANAKA, Kariya-city (JP)

(21) Appl. No.: 19/299,093

(22) Filed: Aug. 13, 2025

Related U.S. Application Data
(63) Continuation of application No. PCT/JP2024/003604, filed on Feb. 5, 2024.

(30) Foreign Application Priority Data
Feb. 17, 2023 (JP) 2023-023235

(51) Int. Cl. H02K 1/2795

(52) U.S. Cl. CPC H02K 1/2795

(57) ABSTRACT

A rotary electric machine includes a stator, and a rotor configured to rotate about a rotation axis and arranged with the stator in an axial direction in which the rotation axis extends. The rotor includes a magnet portion arranged with the stator in the axial direction, and a magnet holder supporting the magnet portion with at least a part of the magnet portion embedded in the magnet holder. The magnet holder includes a holder arrangement portion arranged with the stator in the axial direction, and a magnet cover portion covering at least a part of the magnet portion facing the stator to fix the magnet portion to the holder arrangement portion.

### CROSS REFERENCE TO RELATED APPLICATIONS

The present application is a continuation application of International Patent Application No. PCT/JP2024/003604 filed on Feb. 5, 2024, which designated the U.S. and claims the benefit of priority from Japanese Patent Application No. 2023-023235 filed on Feb. 17, 2023. The disclosures of all the above applications are incorporated herein.

### TECHNICAL FIELD

The disclosure in this specification relates to a rotary electric machine.

### BACKGROUND ART

In an axial gap motor, a rotor and a stator are aligned in an axial direction.

### SUMMARY

According to an aspect of the present disclosure, a rotary electric machine is configured to be driven by a supply of electric power. The rotary electric machine includes a stator, and a rotor configured to rotate about a rotation axis and arranged with the stator in an axial direction in which the rotation axis extends. The rotor includes a magnet portion arranged with the stator in the axial direction, and a magnet holder supporting the magnet portion with at least a part of the magnet portion embedded in the magnet holder. The magnet holder includes a holder arrangement portion arranged with the stator in the axial direction, and a magnet cover portion covering at least a part of the magnet portion facing the stator to fix the magnet portion to the holder arrangement portion.

### BRIEF DESCRIPTION OF DRAWINGS

The details of one or more embodiments are set forth in the accompanying drawings and the description below. Other features and advantages will be apparent from the description and drawings, and from the claims.

FIG. 1 is a diagram illustrating a configuration of an eVTOL according to a first embodiment.

FIG. 2 is a diagram illustrating an electrical configuration of a propulsion system.

FIG. 3 is a schematic perspective view of an EPU.

FIG. 4 is a vertical cross-sectional view of a motor device.

FIG. 5 is a perspective view of a first rotor.

FIG. 6 is a vertical cross-sectional view of a motor device.

FIG. 7 is a vertical cross-sectional view of the first rotor.

FIG. 8 is a schematic side view of the first rotor and the stator as viewed from a radially outer side.

FIG. 9 is a vertical cross-sectional view of a first rotor according to a second embodiment.

FIG. 10 is a perspective view of a first rotor according to a third embodiment.

### DETAILED DESCRIPTION

According to a comparative example, an axial gap motor includes a rotor and a stator aligned in an axial direction. In the motor, the rotor and the stator are accommodated in a motor housing. The rotor has a magnet. The magnet provided on the rotor is exposed to the stator.

However, in the comparative example, an abnormality may occur in the rotor, such as a partial detachment of the magnet from the rotor.

In contrast, according to the present disclosure, a rotary electric machine is capable of reducing occurrence of abnormalities in a rotor.

According to a disclosed aspect, a rotary electric machine is configured to be driven by a supply of electric power. The rotary electric machine includes a stator, and a rotor configured to rotate about a rotation axis and arranged with the stator in an axial direction in which the rotation axis extends. The rotor includes a magnet portion arranged with the stator in the axial direction, and a magnet holder supporting the magnet portion with at least a part of the magnet portion embedded in the magnet holder. The magnet holder includes a holder arrangement portion arranged with the stator in the axial direction, and a magnet cover portion covering at least a part of the magnet portion facing the stator to fix the magnet portion to the holder arrangement portion.

According to the above aspect, the magnet cover portion covers at least a part of the magnet portion facing the stator to fix the magnet portion to the holder arrangement portion. In this configuration, the magnet cover portion can prevent at least a part of the magnet portion from being detached from the holder arrangement portion. Thus, an occurrence of abnormalities in the rotor can be reduced.

Hereinafter, embodiments for implementing the present disclosure are described referring to drawings. In each embodiment, the same reference numerals may be given to parts corresponding to matters described in a preceding embodiment, and overlapping explanations may be omitted. When only a part of a configuration is described in an embodiment, the other preceding embodiments can be applied to the other parts of the configuration. It may be possible not only to combine parts which are explicitly described in the embodiments to be able to be combined specifically, but also to partially combine the embodiments without such explicit description unless there is a problem with the combination.

### First Embodiment

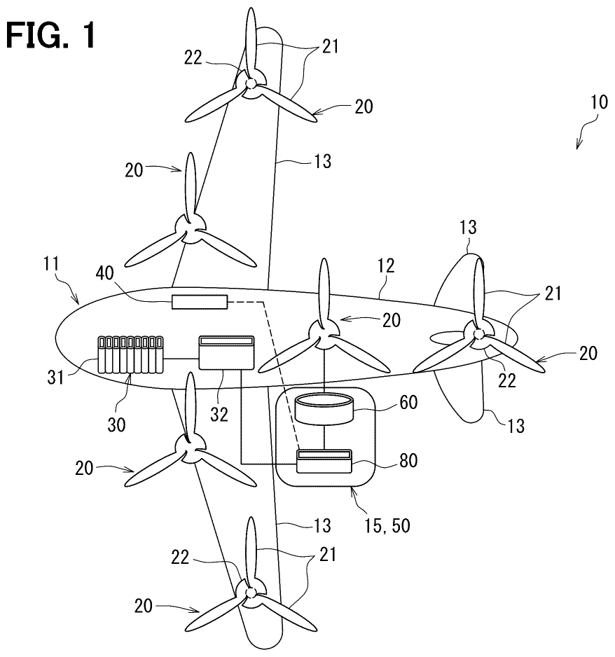

A propulsion system 30 shown in FIG. 1 is mounted in an eVTOL 10. The eVTOL 10 is an electric vertical take-off and landing aircraft, and can take off and land in a vertical direction. The eVTOL is an abbreviation of an electric vertical take-off and landing aircraft. The eVTOL 10 is an aircraft flying in the atmosphere and corresponds to a flight vehicle. The eVTOL 10 is also an electric-type electric aircraft and may be referred to as an electric flight vehicle. The eVTOL 10 is a manned aircraft carrying occupants. The propulsion system 30 is a system that drives the eVTOL 10 to fly.

The eVTOL 10 includes an airframe 11 and propellers 20. The airframe 11 includes an airframe main body 12 and wings 13. The airframe main body 12 is a body of the airframe 11 and has, for example, a shape extending in a front-rear direction. The airframe main body 12 has a passenger compartment for carrying occupants. Each of the wings 13 extends from the airframe main body 12 and multiple wings 13 are provided on the airframe main body 12. The wings 13 are fixed wings. The multiple wings 13 include a main wing, a tail wing, and the like.

The propellers 20 are provided on the airframe 11. The eVTOL 10 is a multicopter including at least three propellers 20. For example, at least four propellers 20 are provided on the airframe 11. The propellers 20 are provided on the airframe main body 12 and the wings 13. Each of the propellers 20 rotates around a propeller axis. The propeller axis is, for example, a center axis of a propeller 20. The propellers 20 can generate thrust and lift in the eVTOL 10. The propellers 20 may be referred to as rotors or rotary wings.

Each of the propellers 20 includes blades 21 and a boss 22. The blades 21 are arranged in a circumferential direction of the propeller axis. The boss 22 couples the multiple blades 21. Each of the blades 21 extends from the boss 22 in a radial direction of the propeller axis. Each of the propellers 20 includes a propeller shaft (not shown). The propeller shaft is a rotary shaft of each propeller 20 and extends along the propeller axis from the boss 22.

The eVTOL 10 is a tilt-rotor aircraft. In the eVTOL 10, tilt angles of the propellers 20 are adjustable. The eVTOL 10 may not be a tilt-rotor aircraft. For example, the eVTOL 10 may include lift-propellers 20 and cruise-propellers 20 which are separated.

The eVTOL 10 includes a battery 31, a distributor 32, a flight control device 40, and EPUs 50. The battery 31, the distributor 32, the flight control device 40, and the EPUs 50 are included in the propulsion system 30. The battery 31 is electrically connected to the EPUs 50. The battery 31 is a power supplying unit that supplies electric power to the EPUs 50, and corresponds to a power supply unit. The battery 31 is a DC voltage source that applies a direct-current voltage to the EPUs 50. The battery 31 has a rechargeable secondary battery. The battery 31 also supplies electric power to the flight control device 40. In addition to or instead of the battery 31, a fuel cell, a generator, or the like may be used as the power supply unit.

The distributor 32 is electrically connected to the battery 31 and the EPUs 50. The distributor 32 distributes the electric power from the battery 31 to the EPUs 50. The electric power distributed to the EPUs 50 by the distributor 32 is drive power for driving the EPUs 50.

The flight control device 40 controls the propulsion system 30. The flight control device 40 performs flight control for causing the eVTOL 10 to fly. The flight control device 40 is communicably connected to the EPUs 50. The flight control device 40 individually controls the EPUs 50. The flight control device 40 controls the EPUs 50 via a control circuit 160 to be described later. The flight control device 40 controls the control circuit 160.

Each of the EPUs 50 is a device for driving the propellers 20 to rotate, and corresponds to a drive device. EPU is an abbreviation of an electric propulsion unit. The EPUs 50 may be referred to as a power drive device or a power drive system. The EPUs 50 are provided individually for each of the propellers 20. The EPUs 50 are arranged on the propellers 20 along their propeller axes. All of the EPUs 50 are fixed on the airframe 11. The EPUs 50 rotatably support the propellers 20. The EPUs 50 are connected to the propellers 20. The propellers 20 are fixed to the airframe 11 via the EPUs 50. When the tilt angles of the propellers 20 are changed, angles of the EPUs 50 are also changed.

The eVTOL 10 includes propulsion devices 15. The propulsion devices 15 are devices for propelling the eVTOL 10. The eVTOL 10 can fly, such as lift, by propulsion of the propulsion devices 15. The propulsion devices 15 includes the propellers 20 and the EPUs 50. In the propulsion devices 15, the EPUs 50 are driven to rotate the propellers 20. The propellers 20 corresponds to a rotary body. The eVTOL 10 flies by rotating the propellers 20. That is, the eVTOL 10 moves by rotating the propellers 20. The eVTOL 10 corresponds to a moving object.

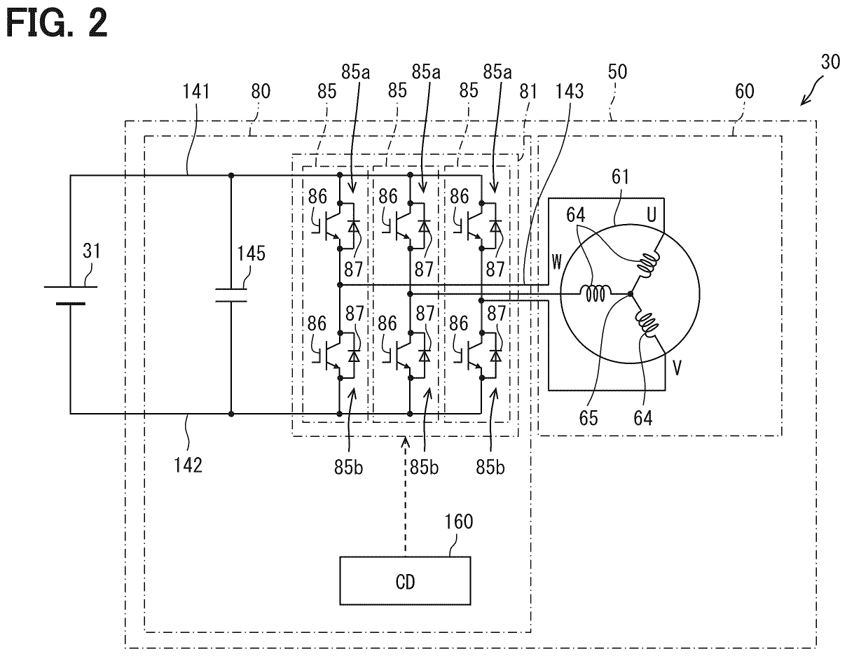

As shown in FIGS. 1 and 2, each of the EPUs 50 includes a motor device 60 and an inverter device 80. The motor device 60 includes a motor 61. The motor device 60 corresponds to a rotary electric machine. The inverter device 80 includes an inverter 81. The motor 61 is electrically connected to the battery 31 via the inverter 81. The motor 61 is driven in response to the electric power supplied from the battery 31 via the inverter 81.

The motor 61 is a multi-phase alternating-current motor. The motor 61 is, for example, a three-phase alternating-current motor, and has a U-phase, a V-phase, and a W-phase. The motor 61 is a movement driving source for moving the moving object, and functions as an electric motor. As the motor 61, for example, a brushless motor is used. The motor 61 functions as a generator during regeneration. The motor 61 includes coils 64 of multiple phases. The coils 64 are windings and form an armature. The coils 64 are provided for each of the U-phase, the V-phase, and the W-phase. In the motor 61, the coils 64 of multiple phases are connected to one another by a neutral point 65.

In FIG. 2, the inverter 81 drives the motor 61 by converting the electric power to be supplied to the motor 61. The inverter 81 converts the electric power supplied to the motor 61 from a direct current to an alternating current. The inverter 81 is a power conversion unit that converts the electric power. The inverter 81 is a multi-phase power conversion unit, and performs power conversion for each of the multiple phases. The inverter 81 is, for example, a three-phase inverter, and performs power conversion for each of the U-phase, the V-phase, and the W-phase. The inverter device 80 may be referred to as a power conversion device.

The inverter device 80 includes a P-line 141 and an N-line 142. The P-line 141 and the N-line 142 electrically connect the battery 31 and the inverter 81. The P-line 141 is electrically connected to a positive electrode of the battery 31. The N-line 142 is electrically connected to a negative electrode of the battery 31. In the battery 31, the positive electrode is an electrode on a high potential side, and the negative electrode is an electrode on a low potential side. The P-line 141 and the N-line 142 are power lines for supplying electric power. The P-line 141 is a power line on the high potential side and may be referred to as a high potential line. The N-line 142 is a power line on the low potential side and may be referred to as a low potential line.

Each of the EPUs 50 includes output lines 143. Each of the output lines 143 is a power line for supplying electric power to the motor 61. The output lines 143 electrically connect the motor 61 and the inverter 81. The output line 143 spans the motor device 60 and the inverter device 80.

The inverter device 80 includes a smoothing capacitor 145. The smoothing capacitor 145 is a capacitor that smooths the direct-current voltage supplied from the battery 31. The smoothing capacitor 145 is connected to the P-line 141 and the N-line 142 between the battery 31 and the inverter 81. The smoothing capacitor 145 is connected in parallel to the inverter 81.

The inverter 81 is a power conversion circuit, for example, a DC-AC conversion circuit. The inverter 81 includes upper and lower arm circuits 85 corresponding to the multiple phases. For example, the inverter 81 includes the upper and lower arm circuits 85 respectively for the U-phase, the V-phase, and the W-phase. Each of the upper and lower arm circuits 85 includes an upper arm 85a and a lower arm 85b. The upper arm 85a and the lower arm 85b are connected in series to the battery 31. The upper arm 85a is connected to the P line 141, and the lower arm 85b is connected to the N line 142.

The output lines 143 are connected to the upper and lower arm circuits 85 for each of the multiple phases. Each of the output lines 143 is connected between the upper arm 85a and the lower arm 85b. The output lines 143 connect the upper and lower arm circuits 85 and the coils 64 for each of the multiple phases. The output lines 143 are connected to ends of the coils 64 on a side opposite to the neutral point 65.

The upper arm 85a and the lower arm 85b each include an arm switch 86 and a diode 87. The arm switch 86 is, for example, a transistor such as an MOSFET. MOSFET is an abbreviation of a metal-oxide-semiconductor field-effect transistor. The arm switch 86 is a switching element, and is capable of converting power by switching. The switch element may be a semi-conductor element such as a power element. The arm switch 86 is a conversion switch for converting electric power.

Each of the EPUs 50 includes the control circuit 160. The control circuit 160 is provided in the inverter device 80. The control circuit 160 controls driving of the inverter 81. The control circuit 160 controls driving of the motor 61 via the inverter 81. The control circuit 160 may be referred to as a motor control unit. In FIG. 2, the control circuit 160 is illustrated as CD.

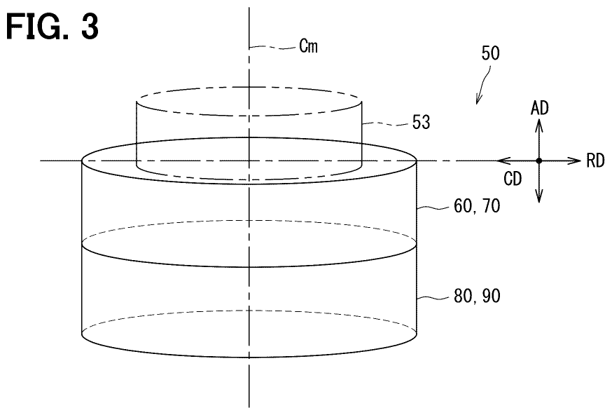

As shown in FIG. 3, in each of the EPUs 50, the motor device 60 and the inverter device 80 are arranged in an axial direction AD along a motor axis Cm. The motor device 60 is provided between a propeller 20 and the inverter device 80 in the axial direction AD. The motor axis Cm is a center axis of the motor 61 and is a virtual line extending linearly. The motor axis Cm corresponds to a rotation axis. The axial direction AD is a direction in which the motor axis Cm extends.

Regarding the motor axis Cm, the axial direction AD, a circumferential direction CD, and a radial direction RD are orthogonal to one another. The circumferential direction CD is a rotation direction of the motor 61. Regarding the radial direction RD, an outer side may be referred to as a radially outer side or an outer peripheral side, and an inner side may be referred to as a radially inner side or an inner peripheral side. The axial direction AD may be referred to as an axial direction.

Each of the EPUs 50 includes a motor housing 70 and an inverter housing 90. The motor housing 70 is included in the motor device 60. The motor housing 70 accommodates the motor 61. The inverter housing 90 is included in the inverter device 80. The inverter housing 90 accommodates the inverter 81. The motor housing 70 and the inverter housing 90 are coupled to each other.

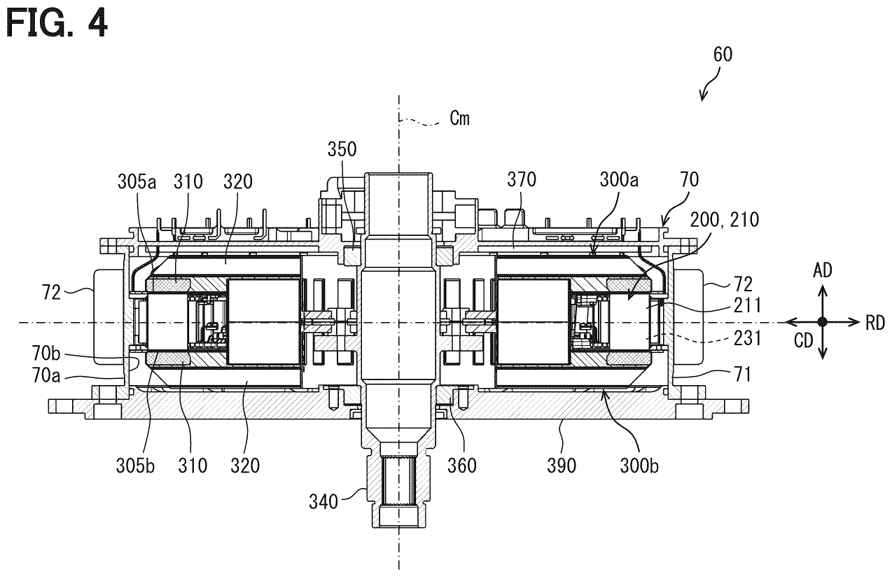

As shown in FIG. 4, the motor housing 70 includes a motor outer peripheral wall 71, a rear frame 370, and a drive frame 390. The motor outer peripheral wall 71 and the frames 370, 390 are made of a metal material or the like and have a thermal conduction property. The motor outer peripheral wall 71 is formed in a tubular shape and extends in the axial direction AD. The frames 370, 390 are formed in a plate shape and extend in a direction orthogonal to the axial direction AD. The rear frame 370 and the drive frame 390 are arranged in the axial direction AD with the motor outer peripheral wall 71 interposed therebetween. The frames 370 and 390 are fixed to the motor outer peripheral wall 71 by fasteners such as bolts. FIG. 4 illustrates a vertical cross-section of the motor device 60 taken along the motor axis Cm.

The motor housing 70 has a motor-housing outer surface 70a and a motor-housing inner surface 70b. The motor-housing outer surface 70a is an outer peripheral surface of the motor housing 70 and is included in an outer surface of the motor housing 70. The motor-housing inner surface 70b is an inner peripheral surface of the motor housing 70 and is included in an inner surface of the motor housing 70. The motor-housing outer surface 70a and the motor-housing inner surface 70b are provided by the motor outer peripheral wall 71.

The rear frame 370 covers an inner space of the motor outer peripheral wall 71 and is provided between the motor outer peripheral wall 71 and the inverter device 80. The rear frame 370 is provided such that the motor outer peripheral wall 71 is between the rear frame 370 and the propeller 20. The drive frame 390 covers the inner space of the motor outer peripheral wall 71 and is provided such that the motor outer peripheral wall 71 is between the drive frame 390 and the inverter device 80. The drive frame 390 is provided between the motor outer peripheral wall 71 and the propeller 20.

The motor housing 70 includes motor fins 72. The motor fins 72 are provided on the outer surface of the motor housing 70. For example, the motor fins 72 are provided on the motor-housing outer surface 70a. The motor fins 72 extend outward from the motor outer peripheral wall 71. The motor fins 72 extend in the direction orthogonal to the circumferential direction CD. The motor fins 72 are arranged in the circumferential direction CD. The motor fins 72 are heat dissipation fins that dissipate heat of the motor device 60 to the outside.

The motor 61 includes a stator 200, a first rotor 300a, a second rotor 300b, and a shaft 340. The stator 200 is a stationary element. The stator 200 includes a coil 64. Each of the rotors 300a, 300b is a rotary element. The rotors 300a, 300b rotate relative to the stator 200. The rotors 300a, 300b rotate about the motor axis Cm. The motor axis Cm is a center axis of each of the rotors 300a, 300b. The stator 200 annularly extends in the circumferential direction CD. The motor axis Cm coincides with the center axis of the stator 200.

The motor device 60 is an axial gap rotary electric machine. The motor 61 is an axial gap motor. In the motor 61, the stator 200 and the rotors 300a, 300b are arranged in the axial direction AD along the motor axis Cm. The motor device 60 is a dual-rotor rotary electric machine. The motor 61 is a dual-rotor motor. The first rotor 300a and the second rotor 300b are arranged in the axial direction AD with the stator 200 interposed therebetween. The stator 200 is provided between two rotors, that is, the first rotor 300a and the second rotor 300b. The motor 61 of the present embodiment may be referred to as a double-axial motor.

The shaft 340 supports the rotors 300a, 300b. The shaft 340 rotates around the motor axis Cm together with the rotors 300a, 300b. A center axis of the shaft 340 coincides with the motor axis Cm. The shaft 340 connects the rotors 300a, 300b to the propeller 20.

Each of the rotors 300a, 300b includes magnet portions 310 and a magnet holder 320. The magnet portions 310 are arranged in the circumferential direction CD in each of the rotors 300a, 300b. Each of the magnet portions 310 includes a permanent magnet and forms a magnetic field. In each of the rotors 300a, 300b, the magnet portions 310 generate a magnetic flux. The magnet portions 310 of the first rotor 300a and the magnet portions 310 of the second rotor 300b are arranged in the axial direction AD with the stator 200 interposed therebetween. The magnet holder 320 supports the magnet portions 310. The magnet holder 320 defines outer and inner circumferential ends of the rotors 300a, 300b.

The stator 200 includes a coil unit 210. The coil unit 210 extends in the circumferential direction CD. The coil unit 210 forms the coils 64. The coil unit 210 includes coil portions 211 and stator cores 231. Each of the coil portion 211 is made of an electric wire, such as a rectangular wire, and conducts electricity. The coil portions 211 are wound around the stator cores 231. Each of the coil portions 211 is formed in a tubular shape as a whole and extends in the axial direction AD. Each of the stator cores 231 is an iron core and extends in the axial direction AD. The coil portions 211 and the stator cores 231 are arranged in the circumferential direction CD along the motor-housing inner surface 70b. In the coil unit 210, the coil portions 211 form the coils 64.

The motor 61 includes a first axial gap 305a and a second axial gap 305b. The axial gaps 305a, 305b are gaps between the stator 200 and the rotors 300a, 300b. The axial gaps 305a, 305b include gaps between the magnet portions 310 and the stator core 231. The axial gaps 305a, 305b extend between the stator 200 and the rotors 300a, 300b in a direction perpendicular to the axial direction AD. The first axial gap 305a is a gap between the stator 200 and the first rotor 300a. The second axial gap 305b is a gap between the stator 200 and the second rotor 300b.

The motor device 60 includes a rear bearing 350 and a drive bearing 360. The bearings 350, 360 rotatably support the shaft 340. The bearings 350, 360 annularly extend in the circumferential direction CD. The rear bearing 350 and the drive bearing 360 are arranged in the axial direction AD with the rotors 300a, 300b interposed therebetween. The bearings 350, 360 are fixed to the motor housing 70. The rear bearing 350 is fixed to the rear frame 370. The drive bearing 360 is fixed to the drive frame 390.

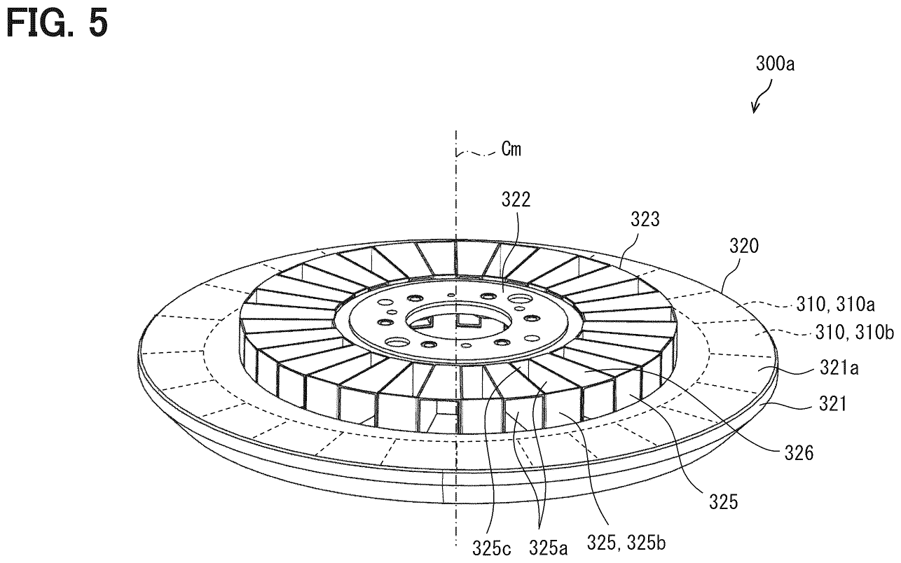

As shown in FIG. 5, the rotors 300a, 300b each have, as the magnet portions 310, first magnet portions 310a and second magnet portions 310b. The magnet portions 310 include the first magnet portions 310a and the second magnet portions 310b. The first magnet portions 310a and the second magnet portions 310b are arranged alternately in the circumferential direction CD.

The magnet holder 320 is made of a resin material or the like. The magnet holder 320 is a non-magnetic element and is formed from a non-magnetic material. For example, the magnet holder 320 is made of CFRP. CFRP is carbon fiber reinforced plastics. The strength and rigidity of the magnet holder 320 are increased by fillers such as carbon fibers.

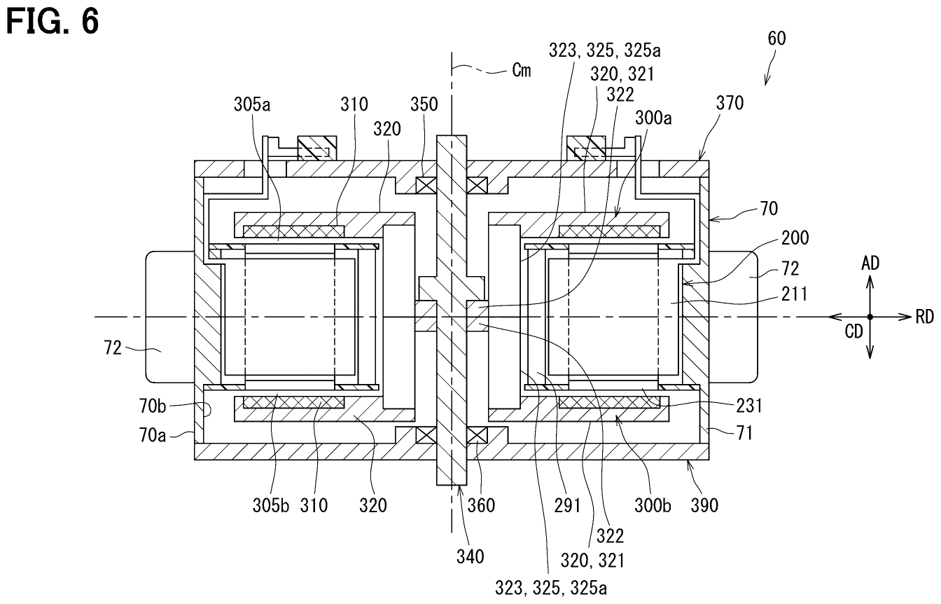

As shown in FIGS. 5 and 6, the magnet holder 320 includes a holder facing portion 321, a holder fixed portion 322, and a holder interposed portion 323. The holder facing portion 321, the holder fixed portion 322, and the holder interposed portion 323 extend annularly in the circumferential direction CD. The holder facing portion 321 forms an outer peripheral end of the magnet holder 320, and is an outer peripheral portion of the magnet holder 320. The holder fixed portion 322 forms an inner peripheral end of the magnet holder 320 and is an inner peripheral portion of the magnet holder 320. The holder interposed portion 323 is provided between the outer peripheral end and the inner peripheral end of the magnet holder 320 in the radial direction RD, and is an intermediate portion of the magnet holder 320.

The holder facing portion 321 faces the stator 200 via the axial gap 305a, 305b. The holder facing portion 321 corresponds to a rotor facing portion. The holder facing portion 321 has a holder facing surface 321a. The holder facing surface 321a is included in an outer surface of the holder facing portion 321. The holder facing surface 321a faces the stator 200 via the axial gap 305a, 305b. At least a part of the holder facing surface 321a defines the axial gap 305a, 305b. The holder facing surface 321a corresponds to a gap facing surface. The holder facing surface 321a extends radially outward and/or radially inward from the axial gap 305a, 305b. The axial gap 305a, 305b corresponds to an axial gap.

The holder facing portion 321 supports the magnet portions 310. In the magnet holder 320, at least a part of each of the magnet portions 310 is embedded in the holder facing portion 321. The magnet portions 310 extend along the holder facing surface 321a inside the holder facing portion 321. The magnet portions 310 are arranged in the circumferential direction CD along the holder facing surface 321a. The magnet portions 310 may be exposed to the axial gap 305a, 305b from the holder facing surface 321a. In this configuration, the holder facing portion 321, the magnet portions 310, or both form the axial gap 305a, 305b.

The holder fixed portion 322 is fixed to the shaft 340. The holder fixed portion 322 corresponds to a rotor fixed portion. The holder fixed portion 322 extends radially outward from the shaft 340. The holder fixed portion 322 is provided at a position spaced apart from the holder facing portion 321 in at least one of the axial direction AD and the circumferential direction CD. For example, the holder fixed portion 322 is provided at a position away from the holder facing portion 321 toward the coil portions 211 in the axial direction AD. The holder fixed portion 322 and the coil portions 211 are arranged in the radial direction RD. The holder fixed portion 322 is located at a position radially inwardly spaced from the coil portions 211.

The holder interposed portion 323 is provided between the holder facing portion 321 and the holder fixed portion 322 in at least one of the axial direction AD and the circumferential direction CD. The holder interposed portion 323 spans from the holder facing portion 321 to the holder fixed portion 322, and connects the holder facing portion 321 to the holder fixed portion 322. The holder interposed portion 323 supports the holder facing portion 321 and the magnet portions 310 while being fixed to the holder fixed portion 322. For example, the holder interposed portion 323 bears load applied to the rotor 300a, 300b. The holder interposed portion 323 is provided radially inward of the axial gap 305a, 305b. The holder interposed portion 323 faces the axial gap 305a, 305b in the radial direction RD.

In this embodiment, the holder interposed portion 323 is arranged with the holder facing portion 321 in both the axial direction AD and the radial direction RD. The holder interposed portion 323 extends toward the frame 370, 390 further than the holder facing surface 321a in the axial direction AD. The holder interposed portion 323 is arranged with the holder fixed portion 322 in the radial direction RD out of the axial direction AD and the radial direction RD.

As shown in FIGS. 5 and 6, the holder interposed portion 323 includes interposed partition portions 325. The interposed partition portions 325 are provided between the holder facing portion 321 and the holder fixed portion 322 in at least one of the axial direction AD and the circumferential direction CD. The interposed partition portions 325 connect the holder facing portion 321 and the holder fixed portion 322 in a state of spanning from the holder facing portion 321 to the holder fixed portion 322. The interposed partition portions 325 support the holder facing portion 321 and the magnet portions 310 while being fixed to the holder fixed portion 322. For example, the interposed partition portions 325 bear load applied to the rotor 300a, 300b. The interposed partition portions 325 are provided radially inward of the axial gap 305a, 305b. The interposed partition portions 325 are arranged with the axial gap 305a, 305b in the radial direction RD.

In this embodiment, the interposed partition portions 325 are arranged with the holder facing portion 321 in both the axial direction AD and the radial direction RD. The interposed partition portions 325 extend toward the frame 370, 390 further than the holder facing surface 321a. The interposed partition portions 325 is arranged with the holder fixed portion 322 in the radial direction RD out of the axial direction AD and the radial direction RD.

The interposed partition portions 325 are arranged in the circumferential direction CD. The interposed partition portions 325 extend radially in the radial direction RD about the motor axis Cm. A center line passing through the center of each of the interposed partition portions 325 and extending in the radial direction RD passes through the motor axis Cm. The outer peripheral end and the inner peripheral end of the interposed partition portion 325 are aligned in the radial direction RD so as not to be misaligned in the circumferential direction CD. The interposed partition portions 325 divide a space between the holder facing portion 321 and the holder fixed portion 322 into spaces arranged in the circumferential direction CD.

The holder facing portion 321 and the holder fixed portion 322 extend in the circumferential direction CD so as to bridge the interposed partition portions 325. The holder facing portion 321 and the holder fixed portion 322 connect each two interposed partition portions 325 adjacent to each other in the circumferential direction CD. The holder interposed portion 323 has partition connection portions 326. The partition connection portions 326 connect each two interposed partition portions 325 adjacent to each other in the circumferential direction CD. The partition connection portions 326 are provided between the holder fixed portion 322 and the coil portions 211 in the radial direction RD.

Each of the interposed partition portions 325 is formed in a tubular shape and extends in the axial direction AD. For example, each of the interposed partition portions 325 is formed in a rectangular tubular shape. Each of the interposed partition portions 325 has partition ribs 325a, an outer peripheral rib 325b, and an inner peripheral rib 325c. Each of the ribs 325a, 325b, 325c has a plate shape. The partition ribs 325a extend in a direction perpendicular to the circumferential direction CD. The partition ribs 325a are a pair of partition ribs included in each of the interposed partition portions 325. The pair of partition ribs 325a are arranged in the circumferential direction CD while the outer peripheral rib 325b and the inner peripheral rib 325c are interposed between the pair of partition ribs 325a. In each of the interposed partition portions 325, the area between the pair of partition ribs 325a is the interior of each interposed partition portion 325.

The outer peripheral rib 325b and the inner peripheral rib 325c extend in a direction perpendicular to the radial direction RD. The outer peripheral rib 325b and the inner peripheral rib 325c are arranged with each other in the radial direction RD across the partition ribs 325a. The outer peripheral rib 325b is provided radially outward of the inner peripheral rib 325c via the partition ribs 325a. The outer peripheral rib 325b and the inner peripheral rib 325c are bridged by the pair of partition ribs 325a. The outer peripheral rib 325b closes a radially outer side of the interior of the interposed partition portion 325. The inner peripheral rib 325c closes a radially inner side of the interior of the interposed partition portion 325.

The interposed partition portions 325 may or may not be hollow. For example, the interposed partition portions 325 do not necessarily have to contain members that fill the interiors of the interposed partition portions 325, but may contain such a member.

In the holder interposed portion 323, the partition ribs 325a, the outer peripheral ribs 325b, and inner peripheral ribs 325c are arranged in the circumferential direction CD. The partition ribs 325a extend radially in the radial direction RD about the motor axis Cm. A center line passing through the center of each of the partition ribs 325a and extending in the radial direction RD passes through the motor axis Cm. The outer peripheral end and the inner peripheral end of each of the partition ribs 325a are aligned in the radial direction RD so as not to be misaligned in the circumferential direction CD.

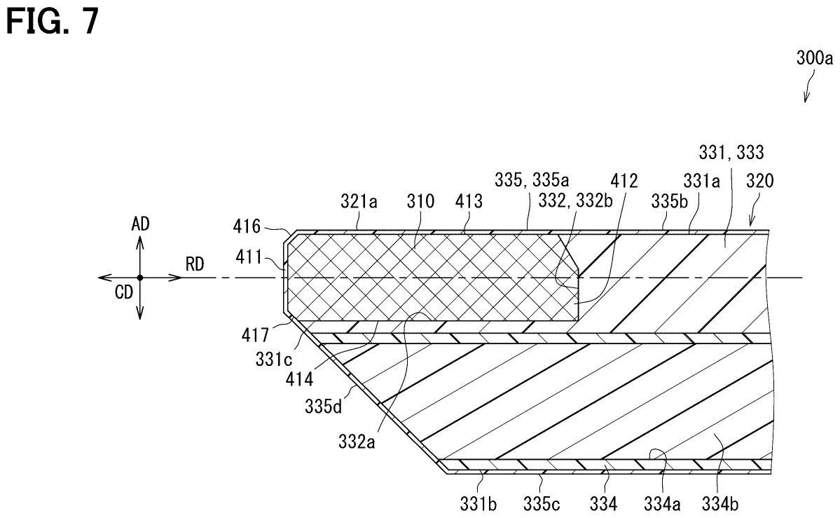

As shown in FIG. 7, the holder facing portion 321 includes a facing base portion 331 and a facing cover portion 335. The facing base portion 331 is arranged with the stator 200 across the axial gap 305a, 305b. The facing base portion 331 corresponds to a holder arrangement portion. The facing cover portion 335 fixes the magnet portions 310 to the facing base portion 331. The magnet portions 310 are provided between the facing base portion 331 and the facing cover portion 335. The facing cover portion 335 is provided between the magnet portions 310 and the stator 200 and covers at least a part of the magnet portions 310, thereby fixing the magnet portions 310 to the facing base portion 331. The facing cover portion 335 corresponds to a magnet cover portion. An outer surface of the facing cover portion 335 is included in an outer surface of the magnet holder 320.

The facing base portion 331 extends annularly in the circumferential direction CD. The facing base portion 331 is formed in a plate shape as a whole and extends in the direction orthogonal to the axial direction AD. The facing base portion 331 includes a first base portion 333 and a second base portion 334. The base portions 333, 334 annularly extend in the circumferential direction CD. The first base portion 333 and the second base portion 334 are overlapped in the axial direction AD. The first base portion 333 is provided between the stator 200 and the second base portion 334.

The second base portion 334 includes base recesses 334a. Each of the base recesses 334a is a recess provided in the second base portion 334, and is recessed radially inward. The base recesses 334a are arranged in the circumferential direction CD. The base recesses 334a accommodate accommodated portions 334b. The inside of each of the base recesses 334a is filled with an accommodated portion 334b. The accommodated portions 334b are included in the second base portion 334. Each of the accommodated portion 334b is formed from a resin material or the like. The accommodated portions 334b do not necessarily have to be accommodated in the base recesses 334a.

The base portions 333, 334 are formed from a resin material or the like. The base portions 333, 334 are non-magnetic elements and are formed from a non-magnetic material. The base portions 333, 334 are formed from CFRP, for example. The strength and rigidity of the base portions 333, 334 are increased by fillers or the like. The first base portion 333 and the second base portion 334 are formed as separate members and fixed together by welding or the like.

The facing base portion 331 includes a base facing surface 331a, a base opposite surface 331b, and a base outer circumferential surface 331c. The base facing surface 331a, the base opposite surface 331b, and the base outer circumferential surface 331c are included in the outer surface of the facing base portion 331. The base facing surface 331a and the base opposite surface 331b extend in a direction perpendicular to the axial direction AD. The base facing surface 331a faces the stator 200 in the axial direction AD. The base facing surface 331a corresponds to a holder arrangement surface. The base opposite surface 331b faces away from the stator 200 in the axial direction AD. The base opposite surface 331b corresponds to a holder opposite surface.

The base outer circumferential surface 331c is an outer circumferential surface of the facing base portion 331. The base outer circumferential surface 331c faces radially outward. At least a part of the base outer circumferential surface 331c is inclined relative to the motor axis Cm. For example, the base outer circumferential surface 331c is inclined relative to the motor axis Cm so as to face away from the stator 200.

The facing base portion 331 includes magnet recesses 332. Each of the magnet recesses 332 is a recess provided in the facing base portion 331. The magnet recesses 332 are arranged in the circumferential direction CD. The magnet recesses 332 are recessed away from the stator 200 in the axial direction AD. The magnet recesses 332 correspond to an arrangement recess. The magnet recesses 332 are recessed radially inward. The magnet recesses 332 are provided on both the base facing surface 331a and the base outer circumferential surface 331c so as to extend beyond the boundary between the base facing surface 331a and the base outer circumferential surface 331c. The base facing surface 331a is open toward the stator 200 and also open radially outward.

Each of the magnet recesses 332 has a recess bottom surface 332a and a recess wall surface 332b. The recess bottom surface 332a and the recess wall surface 332b are inner surfaces of a magnet recess 332. The recess bottom surface 332a faces the stator 200 as a whole. The recess wall surface 332b faces radially outward as a whole.

The magnet portions 310 are inserted into the magnet recesses 332. At least a part of each of the magnet portion 310 is housed in a magnet recess 332. Each of the magnet portions 310 is provided so as not to protrude from the magnet recess 332 towards the stator 200. A part of each of the magnet portions 310 protrudes radially outward from the magnet recess 332. Each of the magnet portions 310 is housed in the magnet recess 332 in a state of contact with the recess bottom surface 332a and the recess wall surface 332b. Each of the magnet portions 310 may be adhered to the recess bottom surface 332a or the recess wall surface 332b with an adhesive or the like.

Each of the magnet portions 310 has a magnet outer peripheral end surface 411, a magnet inner peripheral end surface 412, a magnet facing surface 413, and a magnet opposite surface 414. The magnet outer peripheral end surface 411, the magnet inner peripheral end surface 412, the magnet facing surface 413 and the magnet opposite surface 414 are included in the outer surface of a magnet portion 310. The magnet outer peripheral end surface 411 forms an outer peripheral end of the magnet portion 310 and faces radially outward. The magnet outer peripheral end surface 411 corresponds to an outer peripheral end surface. The magnet inner peripheral end surface 412 forms an inner peripheral end of the magnet portion 310 and faces radially inward. The magnet outer peripheral end surface 411 and the magnet inner peripheral end surface 412 are aligned in the radial direction RD.

The magnet facing surface 413 and the magnet opposite surface 414 extend in a direction perpendicular to the axial direction AD. The magnet facing surface 413 and the magnet opposite surface 414 are aligned in the axial direction AD while the magnet outer peripheral end surface 411 and the magnet inner peripheral end surface 412 are interposed between the magnet facing surface 413 and the magnet opposite surface 414. The magnet facing surface 413 faces the stator 200 in the axial direction AD. The magnet opposite surface 414 faces away from the stator 200 in the axial direction AD.

Each of the magnet portions 310 has a facing chamfered surface 416 and an opposite chamfered surface 417. The chamfered surfaces 416, 417 are formed by chamfering the corners of a magnet portion 310. The chamfered surfaces 416, 417 may be flat or curved. The facing chamfered surface 416 is a chamfered surface obtained by chamfering a corner between the magnet outer peripheral end surface 411 and the magnet facing surface 413. The facing chamfered surface 416 extends to span between the magnet outer peripheral end surface 411 and the magnet facing surface 413. The facing chamfered surface 416 is inclined relative to the motor axis Cm so as to face the stator 200. The opposite chamfered surface 417 is a chamfered surface obtained by chamfering a corner between the magnet outer peripheral end surface 411 and the magnet opposite surface 414. The opposite chamfered surface 417 extends to span between the magnet outer peripheral end surface 411 and the magnet opposite surface 414. The opposite chamfered surface 417 is inclined relative to the motor axis Cm so as to face away from the stator 200.

In each of the magnet portions 310, the magnet facing surface 413 is provided radially outward of the base facing surface 331a. The magnet facing surface 413 and the base facing surface 331a are aligned in the radial direction RD. The magnet facing surface 413 and the base facing surface 331a are provided so as to be flush with each other and extend continuously with each other in the radial direction RD.

A portion of each of the magnet portions 310 that protrudes radially outward from the facing base portion 331 includes the magnet outer peripheral end surface 411, the facing chamfered surface 416, and the opposite chamfered surface 417. The magnet outer peripheral end surface 411 is provided at a position spaced radially outward from the base outer circumferential surface 331c. The opposite chamfered surface 417 extends from the magnet outer peripheral end surface 411 toward the base outer circumferential surface 331c. The opposite chamfered surface 417 and the base outer circumferential surface 331c are provided so as to be flush with each other and extend continuously with each other.

The facing cover portion 335 is formed from a resin material or the like. The facing cover portion 335 is a non-magnetic element and is made of a non-magnetic material. The facing cover portion 335 is formed from CFRP, for example. The facing cover portion 335 has strength and rigidity reinforced by filler or the like. The strength and rigidity of the facing cover portion 335 are greater than the strength and rigidity of the facing base portion 331.

The facing cover portion 335 covers the magnet portions 310 from their sides facing away from the magnet recesses 332. The facing cover portion 335 covers and conceals the sides of the magnet portions 310 facing the stator 200 and radially outward. The facing cover portion 335 covers the magnet portions 310 so that the magnet portions 310 are not exposed to the outside of the magnet holder 320. The facing cover portion 335 is fixed to the facing base portion 331, thereby fixing the magnet portions 310 to the facing base portion 331. The facing cover portion 335 is overlapped on the outer surface of the facing base portion 331 so as to extend along the outer surface of the facing base portion 331. The facing cover portion 335 is fixed to the outer surface of the facing base portion 331 by welding or the like.

The facing cover portion 335 includes a cover contact portion 335a, a facing contact portion 335b, an opposite contact portion 335c, and an outer circumferential contact portion 335d. The cover contact portion 335a is in contact with the outer surfaces of the magnet portions 310. The cover contact portion 335a is overlapped with at least the magnet outer peripheral end surface 411 and the magnet facing surface 413. The cover contact portion 335a is in a state of spanning from the magnet outer peripheral end surface 411 to the magnet facing surface 413 via the facing chamfered surface 416. The facing chamfered surface 416 prevents the cover contact portion 335a from becoming bent or folded. For example, the facing chamfered surface 416 prevents the cover contact portion 335a from being bent, thereby preventing the filler, such as carbon fiber, contained in the cover contact portion 335a from being broken. Therefore, it is unlikely that the strength or rigidity of the cover contact portion 335a will decrease due to bending of the cover contact portion 335a.

The facing contact portion 335b, the opposite contact portion 335c and the outer circumferential contact portion 335d are in contact with the outer surface of the facing base portion 331. The facing contact portion 335b is overlapped and fixed to the base facing surface 331a. The facing contact portion 335b forms the holder facing surface 321a. The opposite contact portion 335c is overlapped with and fixed to the base opposite surface 331b. The outer circumferential contact portion 335d is overlapped with and fixed to the base outer circumferential surface 331c.

In the facing cover portion 335, the cover contact portion 335a and the outer circumferential contact portion 335d are in a state of spanning from the magnet outer peripheral end surface 411 to the base outer circumferential surface 331c via the opposite chamfered surface 417. The opposite chamfered surface 417 prevents the cover contact portion 335a and the outer circumferential contact portion 335d from becoming bent. For example, the opposite chamfered surface 417 prevents the cover contact portion 335a or the outer circumferential contact portion 335d from becoming bent, thereby preventing the filler, such as carbon fiber, contained in the cover contact portion 335a or the outer circumferential contact portion 335d from breaking. Therefore, it is unlikely that the strength or rigidity of the cover contact portion 335a or the outer circumferential contact portion 335d will decrease due to bending of the cover contact portion 335a or the outer circumferential contact portion 335d.

The facing cover portion 335 spans from the base facing surface 331a to the base opposite surface 331b via the magnet portions 310. The facing cover portion 335 is fixed to the base facing surface 331a and the base opposite surface 331b, thereby supporting the magnet portions 310. In the facing cover portion 335, the facing contact portion 335b and the opposite contact portion 335c are connected through the cover contact portion 335a and the outer circumferential contact portion 335d. The facing contact portion 335b and the opposite contact portion 335c support the magnet portions 310 via the cover contact portion 335a and the outer circumferential contact portion 335d.

The facing cover portion 335 spans from the first base portion 333 to the second base portion 334 via the magnet portions 310. The base facing surface 331a is included in the outer surface of the first base portion 333. The base opposite surface 331b is included in the outer surface of the second base portion 334. The facing cover portion 335 is fixed to the base facing surface 331a, and thereby fixed to the first base portion 333. The facing cover portion 335 is fixed to the base opposite surface 331b, and thereby fixed to the second base portion 334. The facing cover portion 335 covers at least a part of the first base portion 333 from its side facing the stator 200. The facing cover portion 335 covers both the first base portion 333 and the second base portion 334 from their sides facing away from the stator 200.

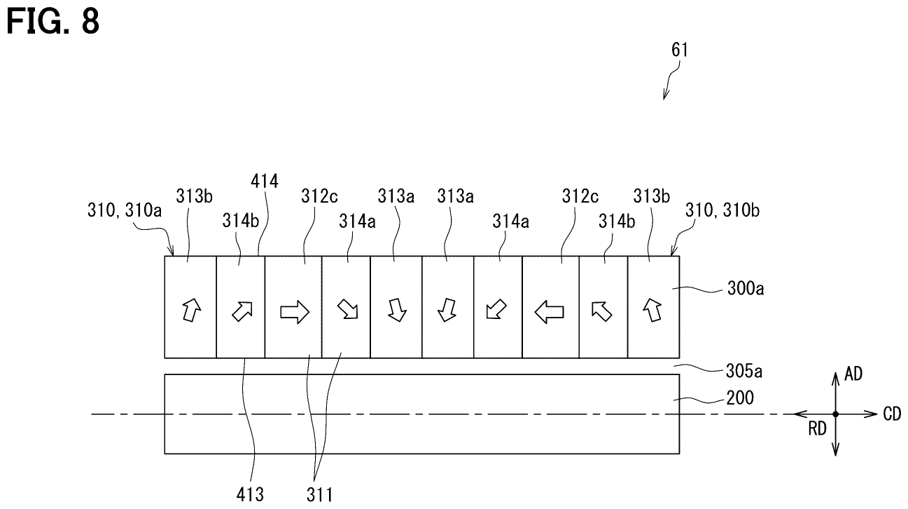

As shown in FIG. 8, each of the magnet portions 310 includes magnets 311. The magnets 311 are arranged in the circumferential direction CD in each of the rotors 300a, 300b and the magnet portions 310. The magnets 311 are arranged in the rotation direction of the rotors 300a, 300b. Two magnets 311 adjacent to each other in the circumferential direction CD are fixed to each other by adhesive or the like. The magnets 311 are permanent magnets. The magnets 311 are each formed in a columnar shape and extend in the circumferential direction CD. In each of the magnet portions 310, the magnets 311 are arranged so as to strengthen the magnetic force generated in the rotors 300a, 300b and the stator 200. For example, the magnet portions 310 are arranged in a Halbach array.

The rotors 300a, 300b each have, as the magnets 311, a q-axis magnet, a d-axis magnet, and an intervening magnet. The q-axis magnet, the d-axis magnet and the intervening magnet are included in each of the magnet portions 310. The orientation directions of the q-axis magnet, the d-axis magnet, and the intervening magnet are different. The orientation direction is one of easy magnetization directions of the magnets 311. The easy magnetization direction is a direction in which an axis of easy magnetization extends. The d-axis magnet is a magnet that has a large orientation component in the axial direction AD. The q-axis magnet is a magnet that has a large orientation component in the circumferential direction CD. The d-axis magnet and the q-axis magnet are arranged in the circumferential direction CD with an intervening magnet interposed therebetween. The q-axis magnet, the d-axis magnet, and the intervening magnet are arranged in the circumferential direction CD, and correspond to rotor magnets.

Each of the magnet portions 310 includes, as the magnets 311, an intermediate q-axis magnet 312c, a first d-axis magnet 313a, a second d-axis magnet 313b, a first intervening magnet 314a, and a second intervening magnet 314b. The d-axis magnets 313a, 313b have a larger orientation component in the axial direction AD than the intermediate q-axis magnet 312c and the intervening magnets 314a, 314b. The d-axis magnets 313a, 313b correspond to a rotor magnet and an axial magnet. The first d-axis magnet 313a and the second d-axis magnet 313b are arranged in the circumferential direction CD while the intermediate q-axis magnet 312c and the intervening magnets 314a, 314b are interposed between the first d-axis magnet 313a and the second d-axis magnet 313b. The orientation direction of the first d-axis magnet 313a and the orientation direction of the second d-axis magnet 313b are opposite to each other in the axial direction AD.

The intermediate q-axis magnet 312c has a larger orientation component in the circumferential direction CD than the d-axis magnets 313a, 313b and the intervening magnets 314a, 314b. The intermediate q-axis magnet 312c corresponds to a rotor magnet and a circumferential magnet. The intermediate q-axis magnet 312c is provided between the first d-axis magnet 313a and the second d-axis magnet 313b in the circumferential direction CD. The orientation direction of the intermediate q-axis magnet 312c is a direction toward one of the first d-axis magnet 313a and the second d-axis magnet 313b.

The intervening magnets 314a, 314b have a smaller orientation component in the axial direction AD than the d-axis magnets 313a, 313b, and a larger orientation component in the axial direction AD than the intermediate q-axis magnet 312c. The intervening magnets 314a, 314b have a smaller orientation component in the circumferential direction CD than the intermediate q-axis magnet 312c, and a larger orientation component in the circumferential direction CD than the d-axis magnets 313a, 313b. The intervening magnets 314a, 314b correspond to rotor magnets. The first intervening magnet 314a and the second intervening magnet 314b are arranged in the circumferential direction CD between the first d-axis magnet 313a and the second d-axis magnet 313b, while the intermediate q-axis magnet 312c interposed between the first intervening magnet 314a and the second intervening magnet 314b. The first intervening magnet 314a is provided between the first d-axis magnet 313a and the intermediate q-axis magnet 312c. The second intervening magnet 314b is provided between the second d-axis magnet 313b and the intermediate q-axis magnet 312c. The orientation direction of the first intervening magnet 314a and the orientation direction of the second intervening magnet 314b are opposite to each other in the axial direction AD.

As shown in FIG. 8, the orientation directions of the magnets 312c, 313a, 313b, 314a, 314b in the first magnet portion 310a is opposite to those in the second magnet portion 310b in the circumferential direction CD. Three magnet portions 310 will be described below: one second magnet portion 310b and two first magnet portions 310a adjacent to each other in the circumferential direction CD via this second magnet portion 310b. In these magnet portions 310, the orientation directions of the magnets 312c, 313a, 313b, 314a, 314b in one of the two first magnet portions 310a and those in the second magnet portion 310b face each other in the circumferential direction CD. The orientation directions of the magnets 312c, 313a, 313b, 314a, 314b in the other of the two first magnet portions 310a and those in the second magnet portion 310b face away from each other in the circumferential direction CD.

According to the present embodiment described above, the facing cover portion 335 is provided between the magnet portions 310 and the stator 200 and covers at least a part of the magnet portions 310 so as to fix the magnet portions 310 to the facing base portion 331. In this configuration, the facing cover portion 335 can prevent at least a part of the magnet portions 310 from detaching from the facing base portion 331. Thus, an occurrence of abnormalities in the rotors 300a, 300b can be reduced.

According to this embodiment, the magnet recesses 332 are recessed in a direction away from the stator 200, and at least a part of the magnet portions 310 are housed in the magnet recesses 332. In this configuration, at least a part of the magnet portions 310 is embedded in the facing cover portion 335, so that the protruding dimension of the magnet portions 310 from the facing cover portion 335 can be reduced. This makes it easy to realize a configuration in which the facing cover portion 335 covers the magnet portions 310 so that no gap is generated between the facing cover portion 335 and the facing base portion 331. Therefore, it is possible to firmly fix the facing cover portion 335 to the facing base portion 331 and to reliably hold the magnet portions 310 by the facing cover portion 335.

According to this embodiment, the magnet recesses 332 are recessed radially inward. In this configuration, the magnet portions 310 can be disposed at the outer circumferential end of the facing base portion 331. Therefore, there is no need to provide a part of the facing base portion 331 radially outward of the magnet portions 310. If a portion of the facing base portion 331 is not provided radially outward of the magnet portions 310, the facing base portion 331 can be reduced in size in the radial direction RD by that amount.

Moreover, the facing cover portion 335 covers at least a part of the magnet portions 310 from the radially outer side. Therefore, even if a part of the facing base portion 331 is not provided radially outward from the magnet portions 310, the facing cover portion 335 can prevent the magnet portions 310 from detaching radially outward from the magnet recesses 332. Therefore, it is possible to both reduce the size of the rotors 300a, 300b and reduce the occurrence of abnormalities in the rotors 300a, 300b.

According to this embodiment, the facing cover portion 335 covers at least a part of the facing chamfered surface 416 of the magnet portions 310. In this configuration, since the corner between the magnet outer peripheral end surface 411 and the magnet facing surface 413 is chamfered by the facing chamfered surface 416, the filler of the facing cover portion 335 is less likely to break. Therefore, the facing chamfered surface 416 can prevent the strength and rigidity of the facing cover portion 335 from decreasing.

According to this embodiment, the magnet portions 310 are provided on the facing base portion 331 such that the magnet facing surface 413 and the base facing surface 331a are aligned in the radial direction RD. In this configuration, a step is unlikely to occur between the magnet facing surface 413 and the base facing surface 331a. Therefore, a part of the facing cover portion 335 spanning between the magnet facing surface 413 and the base facing surface 331a does not need to overcome a step. Therefore, the facing cover portion 335 can be easily brought into close contact with both the magnet facing surface 413 and the base facing surface 331a. As a result, the facing cover portion 335 can be fixed to the base facing surface 331a, and the positional deviation of the magnet portions 310 can be limited by the facing cover portion 335.

According to this embodiment, the magnet portions 310 extend radially outward further than the facing base portion 331. In this configuration, by providing the magnet portions 310 as close to the outer periphery as possible relative to facing base portion 331, the axial gaps 305a, 305b can be expanded as far as possible toward the outer periphery. This makes it possible to increase the output of the motor 61 while reducing the size of the magnet holder 320 in the radial direction RD.

Moreover, the facing cover portion 335 covers at least a part of the magnet portions 310 from the outer circumferential side. Therefore, the axial gaps 305a, 305b can be expanded in the radial direction RD while the facing cover portion 335 can prevent the magnet portions 310 from being detached from the facing base portion 331. Furthermore, the portion of the magnet portions 310 that extends radially outward further than the facing base portion 331 is chamfered at the facing chamfered surface 416 and the opposite chamfered surface 417. Therefore, the axial gaps 305a, 305b can be expanded in the radial direction RD, while the chamfered surfaces 416, 417 can prevent the filler of the facing cover portion 335 from breaking.

According to this embodiment, the facing cover portion 335 covers the magnet portions 310 from the side facing the stator 200 so that the magnet portions 310 are not exposed to the stator 200. In this configuration, even if the magnet portions 310 break and small fragments are generated, the facing cover portion 335 can prevent the fragments from scattering. Therefore, the facing cover portion 335 can prevent small fragments of the magnet portions 310 from causing abnormalities in the rotors 300a, 300b.

According to this embodiment, the facing cover portion 335 is overlapped with the base facing surface 331a and the base opposite surface 331b so as to span from the base facing surface 331a to the base opposite surface 331b via the magnet portions 310. In this configuration, by enlarging an area of the facing cover portion 335 that overlaps with the base facing surface 331a and the base opposite surface 331b, the fixing strength of the facing cover portion 335 to the base facing surface 331a and the base opposite surface 331b can be increased. Therefore, the support strength of the magnet portions 310 by the facing cover portion 335 can be increased.

According to the present embodiment, the motor device 60 drives the eVTOL 10 to fly. In this configuration, when the eVTOL 10 is flying due to the drive of motor device 60, the facing cover portion 335 can reduce the occurrence of abnormalities in the rotors 300a, 300b. In this manner, the safety of the eVTOL 10 can be improved by reducing the occurrence of abnormalities in the rotors 300a, 300b.

### Second Embodiment

In the above-described first embodiment, the facing cover portion 335 covers both the first base portion 333 and the second base portion 334 from the side facing away from the stator 200. In contrast, in the second embodiment, only the first base portion 333 is covered from the side facing away from the stator 200, among the first base portion 333 and the second base portion 334. Configurations, operations, and effects not specifically described in the second embodiment are the same as those in the above-described first embodiment. In the second embodiment, differences from the above-described first embodiment will be mainly described.

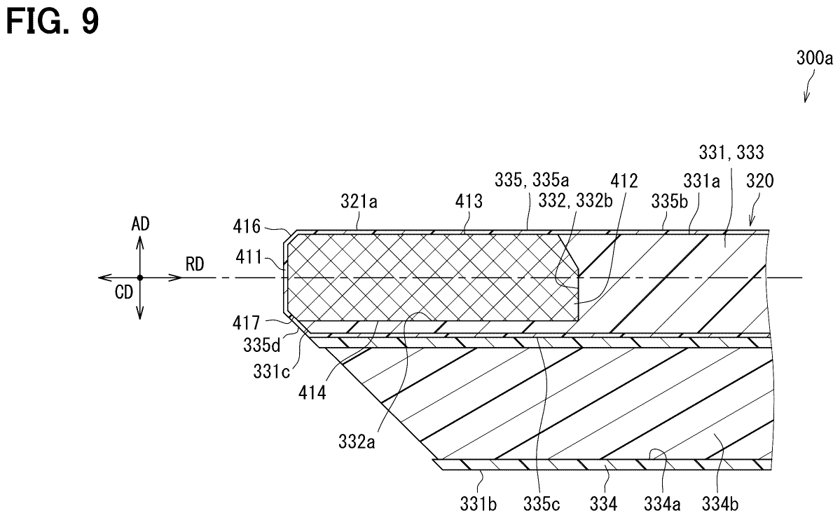

As shown in FIG. 9, a facing cover portion 335 does not cover the second base portion 334 from the side opposite from the stator 200. A portion of the facing cover portion 335 is inserted between the first base portion 333 and the second base portion 334. In the facing cover portion 335, an opposite contact portion 335c is provided between the first base portion 333 and the second base portion 334. The opposite contact portion 335c is fixed to both the first base portion 333 and the second base portion 334 by welding or the like. The second base portion 334 is fixed to the first base portion 333 via the opposite contact portion 335c.

### Third Embodiment

In the above-described first embodiment, the facing cover portion 335 covers the magnet portions 310 so that the magnet portions 310 are not exposed. In contrast, in the third embodiment, a facing cover portion 335 covers the magnet portions 310 with a part of the magnet portions 310 exposed. Configurations, operations, and effects not specifically described in the third embodiment are the same as those in the above-described first embodiment. In the third embodiment, differences from the above-described first embodiment will be mainly described.

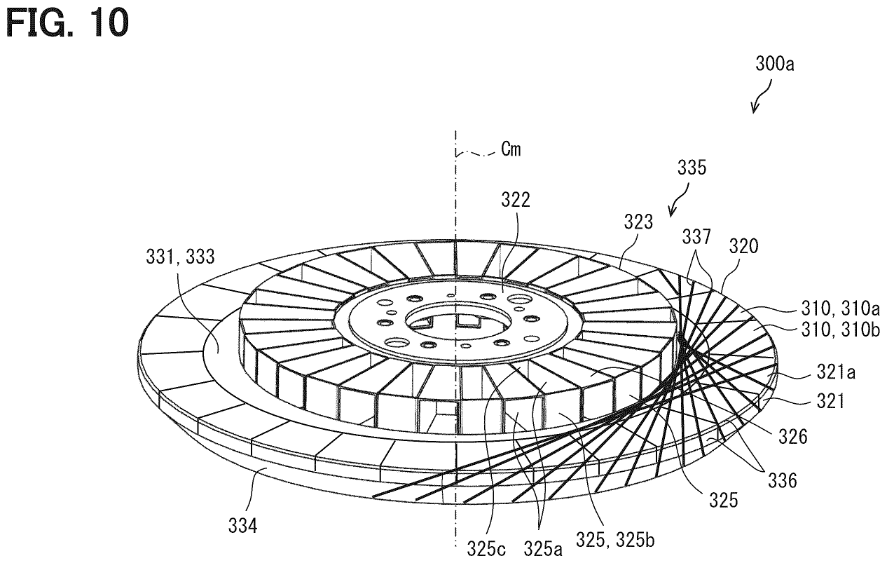

As shown in FIG. 10, the facing cover portion 335 has cover openings 336. The cover openings 336 are arranged along the outer surface of the facing cover portion 335. The magnet portions 310 are exposed to the outside of the magnet holder 320 through the cover openings 336.

The facing cover portion 335 has linear members 337. The linear members 337 are long members that extend linearly. The linear members 337 are made of a resin material. The linear members 337 are a non-magnetic elements and are formed from a non-magnetic material. For example, the linear members 337 are formed of yarn, CFRP, or the like. The strength and rigidity of the linear members 337 are increased by fillers.

The facing cover portion 335 is formed by winding at least one linear member 337 around the facing base portion 331. The linear member 337 is fixed to the facing base portion 331 by welding or the like. For example, the cover openings 336 are gaps in the linear member 337. The linear members 337 may be wound around the facing base portion 331 so that no gap is created. In this configuration, the cover openings 336 are not formed in the facing cover portion 335.

### OTHER EMBODIMENTS

The disclosure of this specification is not limited to the illustrated embodiment. The disclosure encompasses the illustrated embodiments and variations based on the embodiments by those skilled in the art. For example, the disclosure is not limited to the combinations of components and elements shown in the embodiments, and various modifications and implementations can be performed. The disclosure may be implemented in various combinations. The disclosure may have additional portions that may be added to the embodiments. The disclosure encompasses the embodiments in which parts and elements are omitted. The disclosure encompasses replacement or combination of the components and elements between one embodiment and another. The technical scope disclosed in the present disclosure is not limited to the above-described embodiments. It should be understood that some disclosed technical ranges are indicated by description of claims, and includes every modification within the equivalent meaning and the scope of description of claims.

In each of the above embodiments, the magnet recesses 332 may be provided in any manner on the facing base portion 331 as long as it is recessed away from the stator 200 in the axial direction AD. For example, the magnet recesses 332 do not have to be recessed radially inward. In other words, the magnet recesses 332 do not have to be open radially outward. Moreover, the magnet recesses 332 may be recessed toward the stator 200. That is, the magnet recesses 332 may penetrate the facing base portion 331 in the axial direction AD.

In each of the above embodiments, the magnet portions 310 may be provided in any manner on the facing base portion 331 as long as it is fixed to the facing base portion 331 by the facing cover portion 335. For example, the magnet portions 310 may be provided so as to protrude from the facing base portion 331 towards the stator 200. In addition, the magnet portions 310 may be housed in the magnet recesses 332 such that the entire magnet portions 310 fits inside the magnet recesses 332. For example, the magnet portions 310 do not have to protrude radially outward from the facing base portion 331. Furthermore, the magnet portions 310 do not have to be housed in the magnet recesses 332. For example, the magnet recesses 332 do not have to be provided in the facing base portion 331.

In each of the above embodiments, the facing cover portion 335 may be included in any portion of the magnet holder 320 as long as it is included in the magnet holder 320. For example, the facing cover portion 335 may be included in the holder fixed portion 322 or the holder interposed portion 323.

In each of the embodiments described above, the motor 61 may not be a dual-rotor motor. For example, the motor 61 may be a single-rotor motor.

In each of the embodiments described above, the flight vehicle on which the motor device 60 is mounted may not be the vertical take-off and landing aircraft as long as being of an electric type. For example, the flight vehicle may be a flight vehicle capable of taking off and landing while gliding, as an example of the electric aircraft. The flight vehicle may be a rotorcraft, or a fixed-wing aircraft. The flight vehicle may be an unmanned flight vehicle carrying no person.

In each of the embodiments described above, the moving object on which the motor device 60 is mounted may not be a flight vehicle as long as the moving object is movable by rotation of the rotary body. For example, the moving object may be a vehicle, a ship, a construction machine, or an agricultural machine. For example, when the moving object is a vehicle, a construction machine, or the like, the rotary body is a movement-wheel or the like, and an output shaft portion is an axle or the like. When the moving object is a ship, the rotary body is a propulsion-screw propeller or the like, and the output shaft portion is a propeller shaft or the like. Furthermore, the motor device 60 may be provided in various types of stationary equipment.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A rotary electric machine configured to be driven by a supply of electric power, the rotary electric machine comprising:
a stator; and
a rotor configured to rotate about a rotation axis and arranged with the stator in an axial direction in which the rotation axis extends, wherein
the rotor includes
a magnet portion arranged with the stator in the axial direction, and
a magnet holder supporting the magnet portion with at least a part of the magnet portion embedded in the magnet holder,
the magnet holder includes
a holder arrangement portion arranged with the stator in the axial direction, and
a magnet cover portion covering at least a part of the magnet portion facing the stator to fix the magnet portion to the holder arrangement portion,
the holder arrangement portion includes
a holder arrangement surface provided inward of the magnet portion in a radial direction of the rotation axis and facing the stator in the axial direction, and
a base outer circumferential surface facing outward in the radial direction, and
the magnet cover portion is overlapped with the holder arrangement surface and the base outer circumferential surface and spans from the holder arrangement surface to the base outer circumferential surface via the magnet portion.

2. The rotary electric machine according to claim 1, wherein
the holder arrangement portion includes an arrangement recess recessed in a direction away from the stator, and
at least a part of the magnet portion is housed in the arrangement recess.

3. The rotary electric machine according to claim 2, wherein
the arrangement recess is recessed inward in a radial direction of the rotation axis, and
the magnet cover portion covers at least a part of the magnet portion from an outer side in the radial direction.

4. The rotary electric machine according to claim 1, wherein
the magnet portion includes
a magnet facing surface facing the stator in the axial direction,
an outer peripheral end surface facing radially outward, and
a chamfered surface spanning from the magnet facing surface to the outer peripheral end surface, and
the magnet cover portion covers at least a part of the chamfered surface.

5. The rotary electric machine according to claim 1, wherein
the magnet portion includes a magnet facing surface facing the stator in the axial direction, and
the magnet facing surface and the holder arrangement surface are arranged to be aligned in a radial direction of the rotation axis.

6. The rotary electric machine according to claim 1, wherein
the magnet portion extends outward further than the holder arrangement portion in a radial direction of the rotation axis, and
the magnet cover portion covers at least a part of the magnet portion from an outer side in the radial direction.

7. The rotary electric machine according to claim 1, wherein
the magnet cover portion covers the magnet portion to prevent the magnet portion from being exposed toward the stator.

8. The rotary electric machine according to claim 1, wherein
the holder arrangement portion includes
a holder opposite surface opposite from the holder arrangement surface in the axial direction, and facing away from the stator in the axial direction such that the magnet portion is located between the holder opposite surface and the stator in the axial direction, and
the magnet cover portion is overlapped with the holder arrangement surface and the holder opposite surface and spans from the holder arrangement surface to the holder opposite surface via the magnet portion.

9. The rotary electric machine according to claim 1, wherein
the rotary electric machine is provided in a flight vehicle and drives the flight vehicle to fly.
